(19) United States
(12) Patent Application Publication
(10) Pub. No.: US 2016/0012494 A1
(43) Pub. Date: Jan. 14, 2016

(54) COMPUTER-IMPLEMENTED METHOD OF VALUING AUTOMOTIVE ASSETS

(71) Applicant: Vehicle Valuation Systems LLC, Roswell, GA (US)

(72) Inventor: Michael Lasini, Marietta, GA (US)

(21) Appl. No.: 14/330,693

(22) Filed: Jul. 14, 2014

(51) Int. Cl. G06Q 30/02

(52) U.S. Cl. CPC G06Q 30/0278; G06Q 40/08

(57) ABSTRACT

A system and method for valuing automotive assets, according to various embodiments, is configured to receive data regarding a damaged automobile. The system may be configured to calculate a statistical formula based on actual automotive sales data and calculate the value of the damaged automobile in its' damaged, repaired, and previously undamaged states. In various embodiments the system is configured to further calculate the diminution in value of the automobile and display these values to a user.

### BACKGROUND

There are approximately 25 million automotive accidents in the United States every year. While advances in technology have significantly and more consistently reduced the number and severity of the injuries sustained in these accidents, technology has yet to significantly reduce the number of accidents that occur each year. As a result, the monetary losses sustained from these automotive accidents continue to rise year after year. The cost to repair automobiles following an accident must not only take into account the reparative cost to correct physical damage (restore vehicle to its pre-accident state) to the automobile, but must also calculate the diminished fair market value of the automobile following the accident. Oftentimes, diminished value is calculated using obsolete formulas that use a damage modifier that favors insurance companies. Consequently, diminished fair market value is difficult to calculate based on a number of unique characteristics of the automobile, which may include more uncommon makes and models, years, mileage, varying automobile features and accessories, and varying markets.

Various embodiments of the present systems and methods recognize and address the foregoing considerations, and others, of prior art systems and methods.

### SUMMARY OF THE VARIOUS EMBODIMENTS

In various embodiments, a system for valuing automotive assets comprises receiving, from a user (e.g., automobile repair technician, insurance adjustor, or automobile owner), at least the make, model, trim, age, mileage, and an estimate of damage sustained by the automobile. At least partially in response to receiving the data (e.g., information) from the user, the system selects a statistical formula that is derived from actual sales data for damaged automobiles that are substantially similar (e.g., the same make, model, and trim, the same make and model, but for a different trim, etc.) to the automobile defined by the received information. The system then calculates an estimated value of the damaged automobile by applying the received information to the selected statistical formula, and at least partially based on the calculated estimated value, the system also determines a diminished value associated with the damaged automobile if the damaged automobile were repaired. At least one of the estimated value of the damaged automobile and the diminished value of the automobile is then displayed to the user.

In various embodiments, a system for valuing automotive assets comprises: receiving, from a user (e.g., automobile repair technician, insurance adjustor, or automobile owner), at least the make, model, trim, age, mileage, and an estimate of damage sustained by the automobile. In response to receiving the information from the user, the system selects a statistical formula that is derived from actual sales data for damaged automobiles that are substantially similar to the automobile defined by the received data. The system then calculates an estimated value of the damaged automobile by applying the received information to the selected statistical formula and displays the estimated value of the damaged automobile to the user.

In various embodiments, a system for valuing automotive assets comprises receiving, from a user (e.g., automobile repair technician, insurance adjustor, or automobile owner), at least the make, model, trim, age, mileage, and an estimate of damage sustained by the automobile. In response to receiving the information from the user, the system selects: a first statistical formula that is derived from actual sales data for damaged automobiles that are substantially similar to the automobile defined by the received information. The system then selects a second statistical formula that is derived from actual sales data for repaired automobiles that are substantially similar to the automobile defined by the received information. The system then further selects a third statistical formula that is derived from actual sales data for undamaged automobiles that are substantially similar to the automobile defined by the received information. At least partially based on the calculated estimated value for at least one of the damaged automobile, the repaired automobile, and the undamaged automobile, the system calculates: an estimated value of the damaged automobile by applying the received information to the selected first statistical formula. The system then calculates an estimated value of a repaired automobile by applying the received information to the selected second statistical formula. The system then further calculates an estimated value of an undamaged automobile by applying the received information to the selected third statistical formula. The system then displays to the user at least one of: an offer price to purchase the damaged and unrepaired automobile; an offer price to purchase the repaired damaged automobile and; a diminished value associated with the damaged automobile if the automobile were to be repaired.

In various embodiments, instead of displaying to the user at least one of: the offer price to purchase the damaged and unrepaired automobile, the estimated value of the repaired damaged automobile, and the diminished value associated with the damaged automobile if the automobile were to be repaired, the system may be configured to transmit the results to the user via e-mail, via a file (e.g., a .pdf, .csv, etc.) or by any other suitable manner. In other embodiments, the system may be configured to receive multiple damaged automobile inputs simultaneously (e.g., through a batch file or batch input) and transmit multiple estimated values via file, or other suitable output that can be received by the user. In still other embodiments, the system may be configured to receive batch inputs and produce batch outputs that may then be received by other systems that use the batch outputs.

### BRIEF DESCRIPTION OF THE DRAWINGS

Various embodiments of systems and methods for the valuation of damaged automobiles are described below. In the course of this description, reference will be made to the accompanying drawings, which are not necessarily drawn to scale and wherein:

FIG. 1 is a block diagram of an exemplary system for the valuation of damaged automobiles in accordance with an embodiment of the present system;

FIG. 2 is a block diagram of a Valuation Server that may be used in the system shown in FIG. 1;

FIGS. 3A and 3B depict a flowchart that generally illustrates a method for valuing (1) damaged and unrepaired automobiles, (2) damaged and repaired automobiles, and (3) the diminished value associated with a damaged automobile; and

FIGS. 4A-4D are exemplary screen displays for enabling a user to value a damaged automobile.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A computer-implemented method of valuing automotive assets, in various embodiments, is configured to calculate the diminution in the fair market value of a damaged automobile. In particular embodiments, a user enters at least the make, model, trim, age, mileage, and an estimate of the damage sustained by an automobile of interest into the system. In various embodiments, a statistical formula is derived from actual sales data for damaged automobiles that are substantially similar to the automobile entered by the user. The system may, in various embodiments, calculate the estimated value of the damaged automobile by applying the received information to the selected statistical formula.

The system may also, in various embodiments, calculate the fair market value of the damaged automobile if it were to be repaired. In various embodiments, at least the make, model, trim, age, mileage, and an estimate of the damage sustained by the automobile of interest are entered into the system by a user. In various embodiments, a second statistical formula is derived from actual sales data for repaired automobiles that are substantially similar to the automobile entered by the user. The system may, in various embodiments, calculate the estimated value of the automobile if it were repaired by applying the received information to the selected second statistical formula.

Further, the system may also, in various embodiments, calculate the fair market value of the automobile of interest if it were undamaged. In various embodiments, the make, model, trim, age, mileage, and an estimate of the damage sustained by the automobile are entered into the system by a user. In some embodiments, a third statistical formula is derived from actual sales data for undamaged automobiles that are substantially similar to the automobile of interest. The system may, in various embodiments, calculate the estimated value of the automobile if it were undamaged by applying the received information to the selected third statistical formula.

In further embodiments, if data for a particular automobile is not available, or a sufficient amount of data is not available to derive a statistical formula for the particular automobile, the system may be configured to determine the estimated value of the damaged automobile using a surrogate model. In various embodiments, the step of selecting a statistical formula further comprises: (1) identifying a surrogate automobile that is similar to the automobile defined by the received data; (2) selecting a first surrogate statistical formula that is derived from actual sales data for damaged surrogate automobiles; and (3) selecting a second surrogate statistical formula that is derived from actual sales data for undamaged surrogate automobiles. The system may then calculate the estimated value of the automobile of interest, in various embodiments, by: (1) applying the received information to the first surrogate statistical formula to calculate an estimated value for a damaged surrogate automobile; (2) applying the received information to the second surrogate statistical formula to calculate an estimated value for an undamaged surrogate automobile; (3) calculating a ratio of the estimated value for the damaged surrogate automobile to the estimated value for the undamaged surrogate automobile; (4) selecting a second statistical formula that is derived from actual sales data for undamaged automobiles that are substantially similar to the automobile defined by the received data; (5) applying the received information to the second statistical formula to calculate an estimated value for an undamaged automobile that is substantially similar to the automobile defined by the received data; and (6) calculating an estimated value of the damaged automobile defined by the received data by applying the ratio to the estimated value for the undamaged automobile that is substantially similar to the automobile defined by the received data.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The program code may execute entirely on the user's computer, partly on the user's computer, as a stand-alone software package, partly on a user's computer and partly on a remote computer, or entirely on the remote computer or server. In the latter scenario, the remote computer may be connected to the user's computer through any type of network, including but not limited to: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

### Example System Architecture

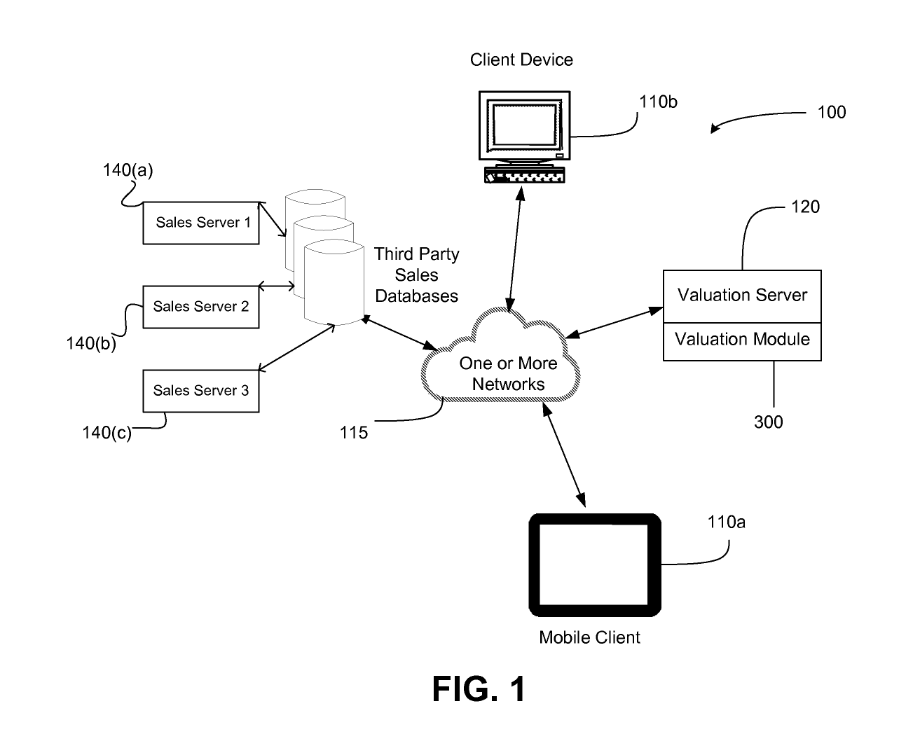

FIG. 1 is a block diagram of an automotive valuation system 100 according to a particular embodiment. As may be understood from this figure, the automotive valuation system 100 includes one or more networks 115, one or more computing devices 110a, 110b (e.g., such as a smart phone, a tablet computer, a wearable computing device, a laptop computer, a desktop computer, etc.), third party sales servers 140a, 140b, 140c and an automotive valuation sever 120 including a valuation module 300.

The one or more networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computing devices). The communication link between the one or more computing devices 110a, 110b and the automotive valuation server 120, third party sales servers 140a, 140b, 140c may be, for example, implemented via a Local Area Network (LAN) or via the Internet.

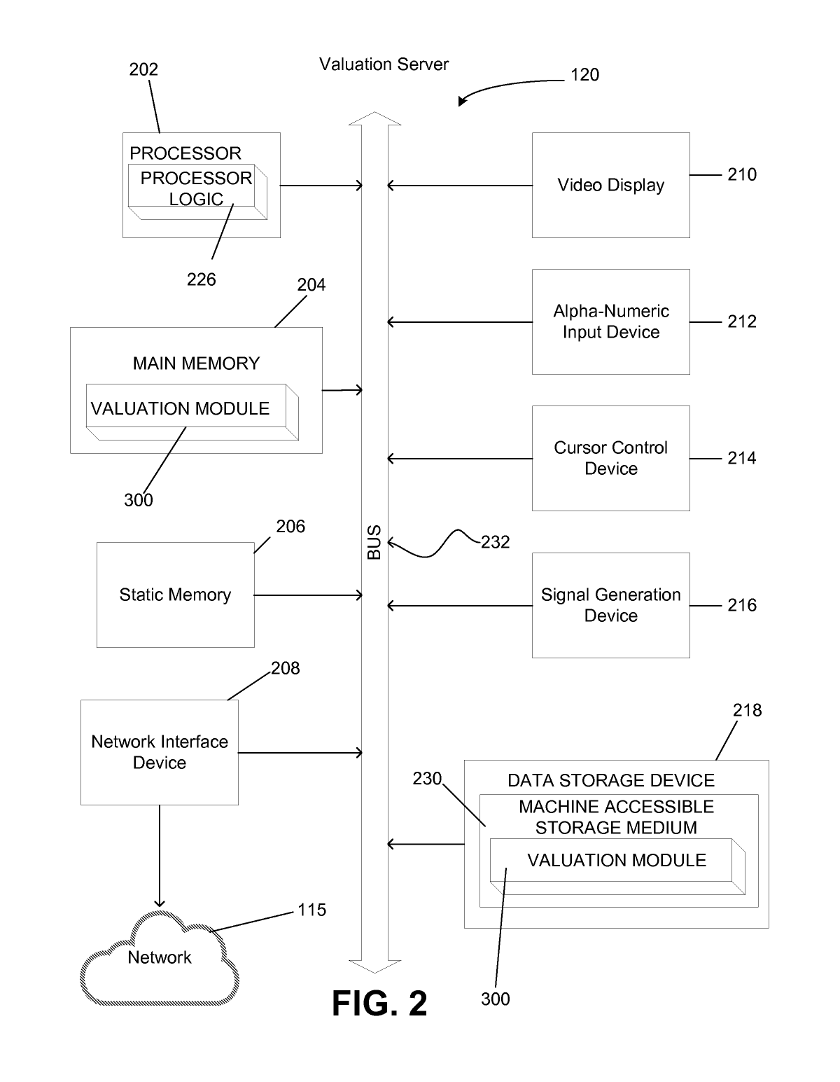

FIG. 2 illustrates a diagrammatic representation of the architecture for the automotive valuation server 120 that may be used within the automotive valuation system 100. It should be understood that the computer architecture shown in FIG. 2 may also represent the computer architecture for any one of the one or more computing devices 110a, 110b, or the one or more third party sales servers 140a, 140b, 140c shown in FIG. 1. In particular embodiments, the automotive valuation server 120 may be suitable for use as a computer within the context of the automotive valuation system 100 that is configured for receiving data from a user regarding a particular damaged automobile, calculating an estimated value of the automobile if it were to be repaired, and/or the diminution in value of the automobile, and displaying the aforementioned estimated value and/or diminution in value and storing said values.

In particular embodiments, the automotive valuation server 120 may be connected (e.g., networked) to other computing devices in a LAN, an intranet, an extranet, and/or the Internet as shown in FIG. 1. As noted above, the automotive valuation server 120 may operate in the capacity of a server or a client computing device in a client-server network environment, or as a peer computing device in a peer-to-peer (or distributed) network environment. The automotive valuation server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein.

An exemplary automotive valuation server 120 includes a processor 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processor 202 represents one or more general-purpose or specific processing devices such as a microprocessor, a central processing unit (CPU), or the like. More particularly, the processor 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processor 202 may also be one or more special-purpose processing devices such as an application specific integrated circuit (ASIC), a field programmable gate array (FPGA), a digital signal processor (DSP), network processor, or the like. The processor 202 may be configured to execute processor logic 226 for performing various operations and steps discussed herein.

The Automotive Valuation Server 120 may further include a network interface device 208. The Automotive Valuation Server 120 may also include a video display 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory machine accessible storage medium 230 (also known as a non-transitory computing device-readable storage medium or a non-transitory computing device-readable medium) on which is stored one or more sets of instructions (e.g., the Valuation Module 300) embodying any one or more of the methodologies or functions described herein. The Automotive Valuation Module 300 may also reside, completely or at least partially, within the main memory 204 and/or within the processor 202 during execution thereof by the Automotive Valuation Server 120—the main memory 204 and the processor 202 also constituting machine accessible storage media. The Valuation Module 300 may further be transmitted or received over a network 115 via a network interface device 208.

While the machine accessible storage medium 230 is shown in an exemplary embodiment to be a single medium, the term “machine accessible storage medium” should be understood to include a single medium or multiple media (e.g., a centralized or distributed database, and/or associated caches and servers) that store the one or more sets of instructions. The term “machine accessible storage medium” should also be understood to include any medium that is capable of storing, encoding, or carrying a set of instructions for execution by the computing device and that causes the computing device to include any one or more of the methodologies of the present invention. The term “machine accessible storage medium” should accordingly be understood to include, but not be limited to, solid-state memories, optical and magnetic media, etc.

### Exemplary System Platform

Various embodiments of a system for the valuation of damaged automobiles are described below and may be implemented in any suitable context. For example, particular embodiments may be implemented within the context of an automotive insurance settlement system to more accurately calculate the diminished value of an automobile after an accident. In still other embodiments, the system may also be integrated into other systems, for example, fleet purchasing systems, automobile salvage systems, etc.

Various aspects of the system's functionality may be executed by certain system modules, including an Valuation Module 300. The Valuation Module 300 is discussed in greater detail below.

Valuation Module

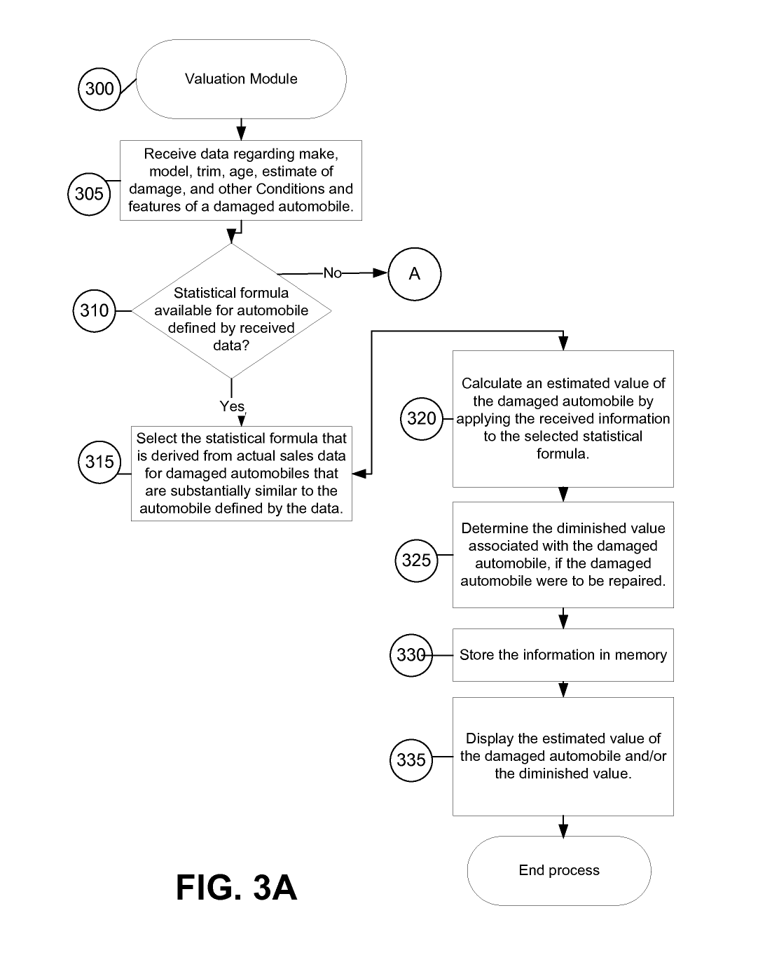

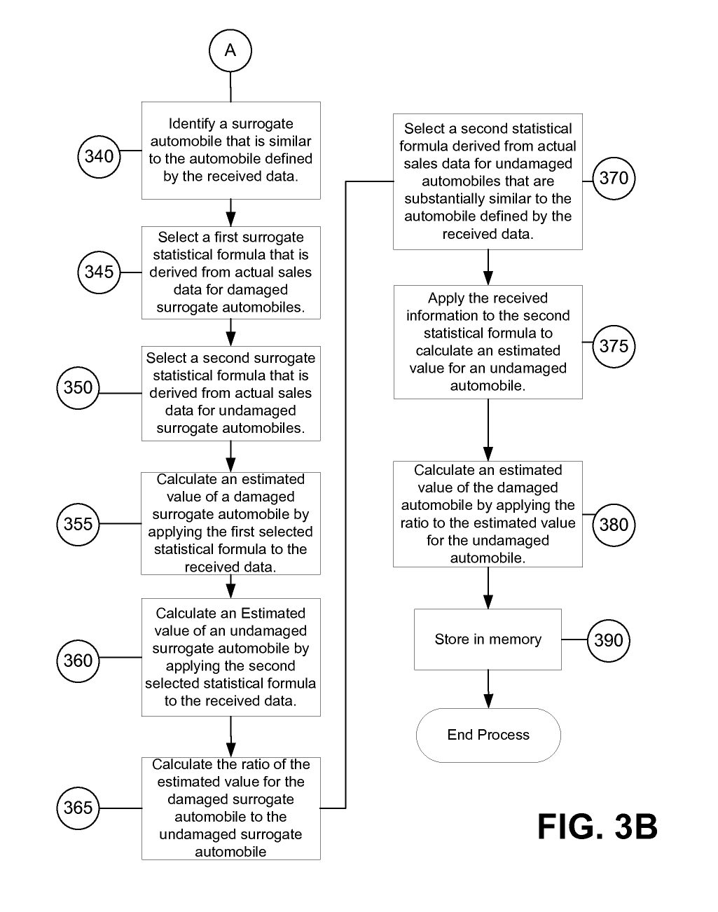

Referring to FIG. 3A, when executing the Valuation Module 300, the system begins, in various embodiments, at Step 305 by receiving information from a user. In various embodiments, the system is configured to receive automobile information from a user (e.g., automobile repair technician, insurance adjustor, or automobile owner, etc.) regarding the condition, age, mileage, and type of automobile, as well as the user's name, address, and contact information. In particular embodiments, a user inputs at least the make, model, trim, age, mileage, and an estimate of damage sustained by the automobile. In various embodiments the system is configured to receive from a user the registration information, mileage, location of the damage, whether the car is drivable, the geographical location of the automobile, type of title, VIN number, number of airbags deployed, condition of the airbags, degree and severity of water damage, degree and severity of glass breakage, and/or the degree of the injuries sustained by the automobile's occupants arising from the accident. In some embodiments, the system may be configured to receive the user input data in batch format. That is, in the case of an insurance company user, the company may upload multiple data sets. The data sets may be in the form of a comma separated file or any other suitable batch file format.

In various embodiments, the system may be configured to receive at least the VIN number from a user, which may be used to determine the make, model, year, trim style, and body type precisely and unambiguously of the automobile. In particular embodiments, entry of the VIN number by a user may also allow the system to lookup an automobile's repair and maintenance records, as well as any available third-party damage estimates associated with the VIN. In some embodiments, the system may also look up the user's information based on the VIN (e.g., the owner's information may be associated with the VIN).

At Step 310, if a statistical formula exists for a substantially similar automobile as defined by the received information, the system selects the statistical formula for the substantially similar automobile of interest at Step 315. If, on the other hand, the system is unable to retrieve a statistical formula for a substantially similar automobile of interest, the system proceeds instead to Step 340, as discussed in more detail below.

In various embodiments, the system is configured to determine whether a statistical formula exists for the automobile defined by the data received in Step 305 by searching memory for a formula that corresponds to a substantially similar automobile (e.g., the same make, model, and trim, the same make and model but for a different trim, etc.) to the automobile defined by the received information. When the statistical formula is for the same make and model but for a different trim, the system may apply a factor to the selected statistical formula to account for the differences in trim. In still other embodiments, the system may choose a statistical formula for the automobile by analyzing the make, model, and trim and assigning the particular automobile defined by the received data into a class of automobiles (e.g., tier one import, tier two imports, tier one domestic, tier two domestic, tier one domestic sports car, tier two domestic sports car, etc.). The system may then select a statistical formula for a substantially similar automobile by selecting a statistical formula that is associated with the particular class of automobiles. In various embodiments, the system may use the statistical formula for the selected class without applying a factor, and in other embodiments, the system may apply a factor since the formula applies to a class of automobiles and not to any one particular automobile.

In various embodiments, the system may be configured to calculate statistical formulas for all makes, models, and trims. In other embodiments, the system may be configured to calculate statistical formulas for all makes, models, and trims that have sufficient sales data associated therewith. Automobile sales data may be obtained from various third-party sales data sources such as auction sales data, national inventory sales data, used car sales data, etc. Moreover, the received sales data may be broken down by sales of damaged automobiles, sales of damaged and repaired automobiles, and sales of undamaged automobiles.

In various embodiments, the system may be configured to calculate the statistical formulas in real-time at the time the system checks to see if a statistical formula exists for a particular make, model, and trim. In these embodiments, the system may make a call to one or more third-party sales servers 140a, 140b, 140c and retrieve sales data that is substantially similar (e.g., that corresponds to the exact make, model, and trim) of the automobile defined by the received information. In other embodiments, the system may be configured to calculate the statistical formulas at predetermined times (e.g., not necessarily when the system determines if a formula exists) and store the statistical formulas in memory for later use. In either case, when the system receives the information from the user, it checks to determine whether a statistical formula is available for a substantially similar make, model, and trim.

If a statistical formula for a substantially similar automobile is available for the automobile defined by the data received in Step 305, the system selects the formula and associates the selected formula with the information input by the user, at Step 315. Continuing at Step 320, the system is configured to calculate an estimated value of the damaged automobile by applying the received information in Step 305 to the selected statistical formula from Step 315. In various embodiments, the system is configured to calculate the estimated value based at least partially on the third-party data received for substantially similar damaged automobiles (e.g., the statistical formulas are derived from actual automobile sales data received from the third-party sales data servers 140a, 140b, 140c, as described below). In particular embodiments, the estimated value of the automobile in question is at least partially based on third-party data for automobiles that are substantially similar with regard to the make, model, and trim type.

Continuing at Step 325, the system is configured to determine the diminished value associated with the damaged automobile if the damaged automobile were to be repaired. In various embodiments, the system at least partially utilizes the estimated value of the damaged automobile, from Step 320, to determine the diminished value of the damaged automobile if the damaged automobile were to be repaired. For example, in various embodiments, the system calculates the diminished value of the damaged automobile by first calculating the estimated value of the automobile if it were to be repaired based at least partially on the data received in Step 305. The system then calculates the estimated value of the damaged automobile if it were undamaged, at least partially based on third-party sales data for substantially similar undamaged automobiles. The diminished value is then calculated by subtracting the estimated value of the automobile if it were to be repaired from the estimated value of an undamaged substantially similar automobile.

Continuing at Step 330, the system is configured to store in memory by conventional methods the estimated value of the damaged automobile, the estimated value of an undamaged substantially similar automobile, the estimated value of the damaged automobile if it were to be repaired, and the resulting diminished value of the automobile. In various embodiments these aforementioned values are stored in temporary memory (e.g., RAM). In various other embodiments these values are stored both in temporary memory and longer-term storage (e.g., a hard disk, portable hard disk, flash drive, tape drive, and/or in a redundant hard disk).

Continuing at Step 335, the system is configured to display, by conventional means (e.g., CRT monitor, LCD display, etc.), at least one of the estimated values of the damaged automobile, the estimated value of the damaged automobile if repaired, the estimated value of a substantially similar automobile if undamaged, and the diminished value of the damaged automobile if it were to be repaired. The aforementioned estimated value and diminished value, as calculated in Steps 320 and 325, respectively, having previously been stored in memory in Step 330, are retrieved by the system by conventional means. Once displayed to the user, the process is ended and the user is able to analyze the estimated values and make decisions with regard to any subjective value the damaged automobile may have (e.g., an owner deciding whether to scrap or repair the automobile, an auto salesman deciding whether to purchase and/or repair an automobile, an automobile broker deciding to purchase the automobile as-is, etc.). In other embodiments the system may, instead of displaying the results, export the results to third-party systems for further analysis. Export of the estimated values may occur for single entries as well as for batch entries. For example, in various embodiments, the system may receive one or more entries that are associated with one or more damaged automobiles (e.g., this may occur when the user is an insurance company). The system may be configured to calculate the estimated values and diminished values for each of the received automobiles and then export the calculated values to a third-party system (e.g., an insurance company claims processing system).

As previously discussed at Step 310, the system is configured to determine whether a statistical formula for a substantially similar automobile exists, based at least partially on the received data in Step 305. Statistical formulas may not exist for a substantially similar automobile, for example, when the received third-party sales data from the sales servers 140a, 140b, 140c do not contain a sufficient sample size of sales data for the substantially similar automobile (e.g., for the exact automobile defined in the received data, for a similar automobile in the same tier as the automobile defined in the received data, etc.). In situations where the system cannot find a statistical formula for a substantially similar automobile as the automobile defined by the received information in Step 305, the system proceeds instead to Step 340, as shown in FIG. 3B.

Continuing at Step 340, the system is configured to identify a surrogate automobile that is similar to the automobile defined by the information received in Step 305. In various embodiments, the statistical formula for the surrogate automobile may be selected for an automobile of the same make and model, but for a different trim from a substantially similar automobile. In other embodiments, the statistical formula for the surrogate automobile may be selected for an automobile that is in the same tier as a substantially similar automobile. For example, automobile information from the third-party sales servers 140a, 140b, 140c may be broken down into tiers based on a variety of factors, for example, similar to how automobiles are currently classified by various governmental, international, and industry standards (e.g., Highway Loss Data Institute Classification system, ISO-3833-1977, ACRISS Car Classification Code, Insurance Institute for Highway Safety, NHTSA, EPA, etc.). In some of these embodiments, the automobile defined by the received information in Step 305 may be classified as a tier 1 import. Thus, when a statistical formula is not available for the substantially similar automobile, the system may search for a formula for another tier 1 import that is similar to the substantially similar automobile.

For example, in various embodiments, the automobile of interest, as defined by the information received in Step 305, is similarly classed into an appropriate tier, and in various embodiments the system is configured to identify a representative automobile from the same aforementioned tier to yield a valid statistical formula. In particular embodiments the surrogate automobile may be identified based at least partially on tier similarity to the automobile defined by the information received in Step 305. In some of these embodiments, the system will further identify within the aforementioned appropriate tier, a surrogate automobile at least partially based on the amount of third-party data available for that surrogate automobile, selecting the surrogate with the most available data rather than the surrogate that is most similar to the automobile of interest since a larger sample population would yield a more-accurate statistical formula.

Once an appropriate surrogate automobile is identified in Step 340, the system, at Step 345 is configured to select a first surrogate statistical formula associated with the surrogate automobile. In various embodiments that first surrogate statistical formula is derived from actual sales data for damaged surrogate automobiles. That is, the first surrogate statistical formula is derived from actual sales data that is received by the system from sales data servers 140a-140c. As described above, the system may calculate the first surrogate statistical formula in real-time or it may select the first statistical formula from a group of predetermined formulas that are stored in memory.

Continuing to Step 350, the system is configured to select a second surrogate statistical formula that is derived from actual sales data for undamaged surrogate automobiles. In particular embodiments, the second surrogate statistical formula utilizes the same surrogate automobile make, model, and trim type as the first surrogate statistical formula from Step 345. Similar to the first surrogate statistical formula, the system may be configured to calculate the second surrogate statistical formula in real-time by making a data call to the third-party sales data servers 140a, 140b, 140c and then calculating the second surrogate statistical formula, or it may select the second surrogate statistical formula from a group of predetermined formulas that are stored in memory.

Continuing to Step 355, the system is configured to calculate an estimated value of a damaged surrogate automobile by applying the selected first surrogate statistical formula from Step 345 to the received information from Step 305. Continuing to Step 360, the system is configured to further calculate an estimated value of an undamaged surrogate automobile by applying the selected second surrogate statistical formula from Step 350 to the received information from Step 305. Continuing to Step 365, the system is configured, in various embodiments, to calculate the ratio of the estimated value of the damaged surrogate automobile, as calculated in Step 355, to the undamaged surrogate automobile, as calculated in Step 360.

Continuing to Step 370, the system is configured to select a second statistical formula that is derived from actual sales data for undamaged automobiles that are substantially similar to the automobile received by the data in Step 305. It should be noted that although there may be a lack of data sufficient to accurately and precisely determine a statistical formula based on sales data for substantially similar, damaged automobiles, there is frequently more actual sales data available to determine a statistical formula based on actual sales data for substantially similar, undamaged automobiles. This is particularly true for new makes, models, and trim designs. Continuing to Step 375, the system is configured to apply at least some of the data received in Step 305 to the second statistical formula of Step 370 to calculate an estimated value for an undamaged automobile that is substantially similar to the automobile defined by the data received in Step 305.

Finally, at Step 380, the system is configured to calculate an estimated value of the damaged automobile. In various embodiments the system calculates the estimated value of the damaged automobile by applying the ratio of the estimated value for the damaged surrogate to the estimated value of the undamaged surrogate, as calculated in Step 365, to the estimated value for the undamaged substantially similar automobile as calculated in the prior Step 375. In various embodiments the system is configured to store the estimated value of the damaged automobile in memory, Step 390, as discussed herein.

It should be understood that the system may also calculate a diminished value for the automobile defined by the data received at Step 305 when using surrogate automobile information similar to that described with respect to Step 325.

### Statistical Modeling Overview

Accurate statistical modeling is inherently dependent on the size and applicability of the collected data set. Generally, larger data sets will provide more-accurate statistical models in terms of generally accepted statistical measurements (i.e., R² value). Larger data sets, however, particularly those obtained from multiple sources, often exhibit a lack of uniformity in notation and scale. In order to have useful data to derive statistical formulae, the raw data is frequently transformed by a number of methods, which may include normalization, de-coupling of variables, or other data-cleaning methods intended to minimize anomalies. In various embodiments, the present system may be configured to receive data from third-party inventory and/or sales databases (e.g., databases and servers 140a-140c) and parse the received data for at least the VIN number of each data line received. The system may further be configured to use the VIN associated with each line of data to search other third-party databases (e.g., Department of Motor Vehicles, state car registration databases, etc.) to populate at least one or more of the make, model, age, trim, and mileage of the automobiles listed by VIN number to create greater consistency in the data set than may be obtainable from the make, model, age, trim, and mileage notations used in various third-party inventory or sales data. In particular embodiments, the system is configured to parse incoming inventory, current inventory, and recent sales data and then to store this data in the system. In particular embodiments, the third party's database may pertain to auction data, sales data, trade-in data, salvage data, and/or repair estimate data. An additional benefit of the aforementioned method of obtaining relevant data for statistical modeling is in the greater accuracy that may be obtained by utilizing the most-recent raw sales data available whether or not the additional necessary fields regarding make, model, and trim type is available. For example, the third-party data received regarding a damaged vehicle of a certain age, make, model, and trim type that has been recently sold is more easily and accurately extrapolated to a vehicle of interest, to the extent the vehicle of interest is located in the same or similar geographical location.

### Alternate Embodiments

In various embodiments, the system, when executing the Valuation Module 300, may omit particular steps, perform particular steps in an order other than the order presented above, or perform additional steps not discussed directly above.

Automated Purchasing of Automobiles

For example, in various embodiments, the system may comprise a Valuation Server, coupled to Third-Party Sales Servers and Databases and a repair database. In such embodiments, the system may be configured to determine the cost of repairs if such work would be performed by a Third-Party, as well as the internal cost if the work were to be performed by the purchasing entity. The system may further determine a threshold profit percentage, based at least partially on the estimated value of the damaged automobile, the estimated value of the repaired automobile, the costs associated with such repairs, a target profit percentage, or on any other suitable data. Thus, the system may be configured to automatically purchase a damaged automobile when the estimated value of the damaged automobile when repaired is sufficiently higher than the combined cost to purchase the damage automobile and repair the automobile when the repairs are performed by the purchasing entity so that the profit percentage is above the threshold profit percentage.

In various embodiments, the one or more repair databases are configured to receive information regarding at least the make, model, age, type, and severity of damage, and the specific parts/labor hours/type of repair necessary to repair the automobile, hereinafter referred to as the itemization of repair. The itemization of repair may be provided by a third-party (e.g., an insurance adjustor, an auto body repair shop, mechanic, etc.). This step is differentiated from, distinct to, and in addition to the aforementioned step of receiving an estimate of the cost to repair a damaged automobile. At least partially in response to receiving the Itemization of Repair information, the system may be further configured to receive data from multiple third-party repair databases, regarding the fixed labor/part prices for specific repairs, and to utilize this information to determine the lowest cost necessary to repair a damaged automobile.

At least partially in response to receiving the Itemization of Repair and determining the cost to repair a damaged automobile, the system may be further configured to estimate the value of a substantially similar repaired automobile by the aforementioned embodiment. At least partially in response to determining the value of a repaired substantially similar automobile, the system is further configured to calculate the percent profit that could be made if the automobile were to be purchased. At least partially in response to determining the percent profit that could be made by purchasing the automobile, the system is further configured to receive Third-Party Sales data and determine the frequency of sales for a particular repaired automobile of a substantially similar make/model/body type within a set amount of time. At least partially in response to the frequency of sales and the percent profit, the system will automatically purchase automobiles when these two aforementioned values exceed pre-determined or user-defined values, that may be changed depending on the user's buying frequency, level of acceptable risk, and current inventory.

System Tracking of Eventual Sale Price and Estimated Sale Price

In various embodiments, the system may be configured to track the predicted value estimations and compare these estimations to the eventual sale prices for automobiles of interest. In particular embodiments, this tracking and comparison is utilized later to improve the estimation formulas. For example, an accurate model must account for asset depreciation, traditional fluctuations due to supply and demand, regional demand, geographical location of the sale, geographical location of the purchase, and a variety of other factors that influence the free market value of an automobile. In order to more-accurately estimate the diminished value, repaired value, and damaged value of a particular automobile, the system may, through at least the VIN number, track the eventual sale of damaged automobiles that are sold damaged or, more importantly, repaired. By comparing the estimated, statistical formula predicted values, with the actual sales data, the system will be able to improve the statistical formulas to more-accurately predict values, while adding additional variables to the analysis in order to more-accurately determine: the estimated sale price, ideal geographical location for sale including fixed shipping costs to reach that geographical location, value variation over time as a factor of both increasing age and time of year (e.g., season, month, etc.), and to account for typical retail year-end sale and new inventory periods that may affect used car pricing.

### Illustrative Examples

### Automotive Insurance Diminution Estimate Application

In a particular example, the system may be implemented in a web-service scenario to provide the owner of a damaged automobile with a more-accurate estimation of the diminution in value of his/her automobile to be utilized in negotiation with their insurance company. As discussed previously, the current methods for calculating the diminution in value of a damaged automobile once it is repaired, rely on an outdated and less-accurate model. Often, the estimate of the diminution in value provided by an insurance company is lower than what would be predicted by the present system, and an alternative calculation method or basis for proposing a more-proper compensation to the owner is unavailable. In a web-based application, this system could be utilized as a one-time, fee-based service, a monthly subscription service that may be utilized by an automotive repair shop, or in any number of combinations of time periods and estimations. This fee structure model is similar to how car history reports are frequently utilized by both automobile dealers on behalf of and as a service to their customers, and customers on their own behalf prior to an automobile purchase.

Auto-Broker Inventory Management Application

In another particular example, the system may be implemented as an asset management application, such as in a large auto brokerage as a manner to evaluate and purchase assets. In either an automated, user-defined threshold triggered (e.g., as utilized in stock transactions, etc.), or manual capacity, the ability of an auto broker to make profit has traditionally correlated with the volume of automobiles purchased and sold. Rather than viewing each transaction on its own merits, auto brokers traditionally buy large quantities of a variety of automobiles to attract the most purchasers in both wholesale and retail settings. The use of this system would allow an auto broker to respond not only to precisely calculated anticipated future trends in price fluctuations in particular automobiles, but would simultaneously allow for a broker to calculate anticipated costs and profits for budgetary and planning purposes. The system would further allow an auto broker to view not only which automobiles would be the most-profitable purchases, but when to purchase and when to sell to maximize potential estimated profits.

### User Experience

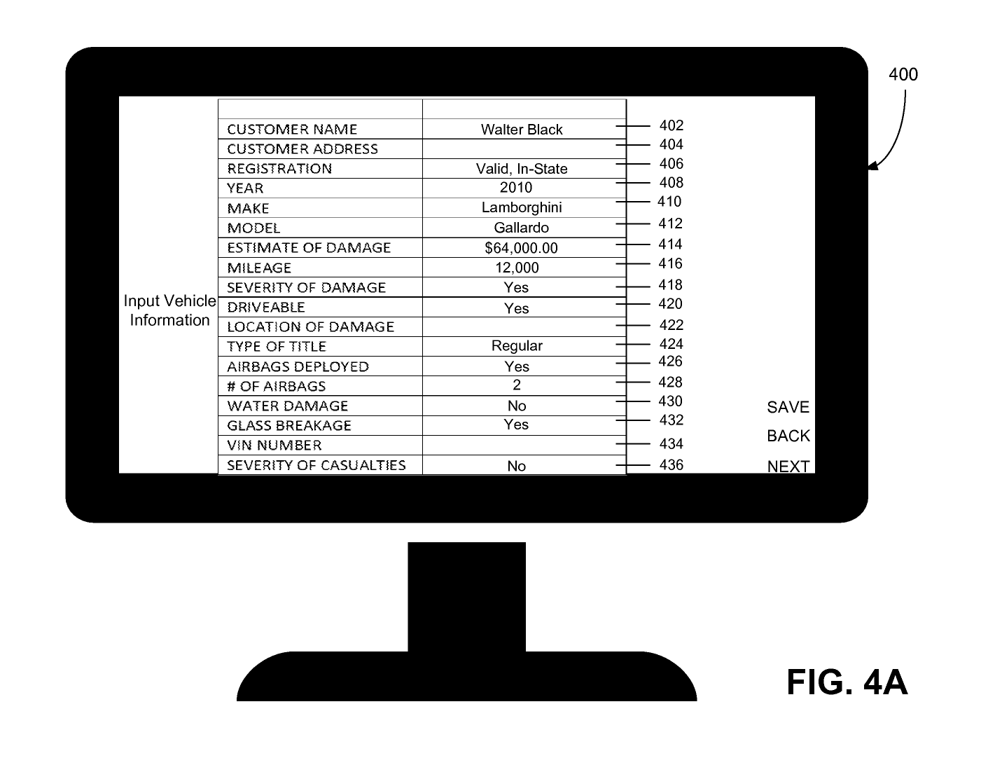

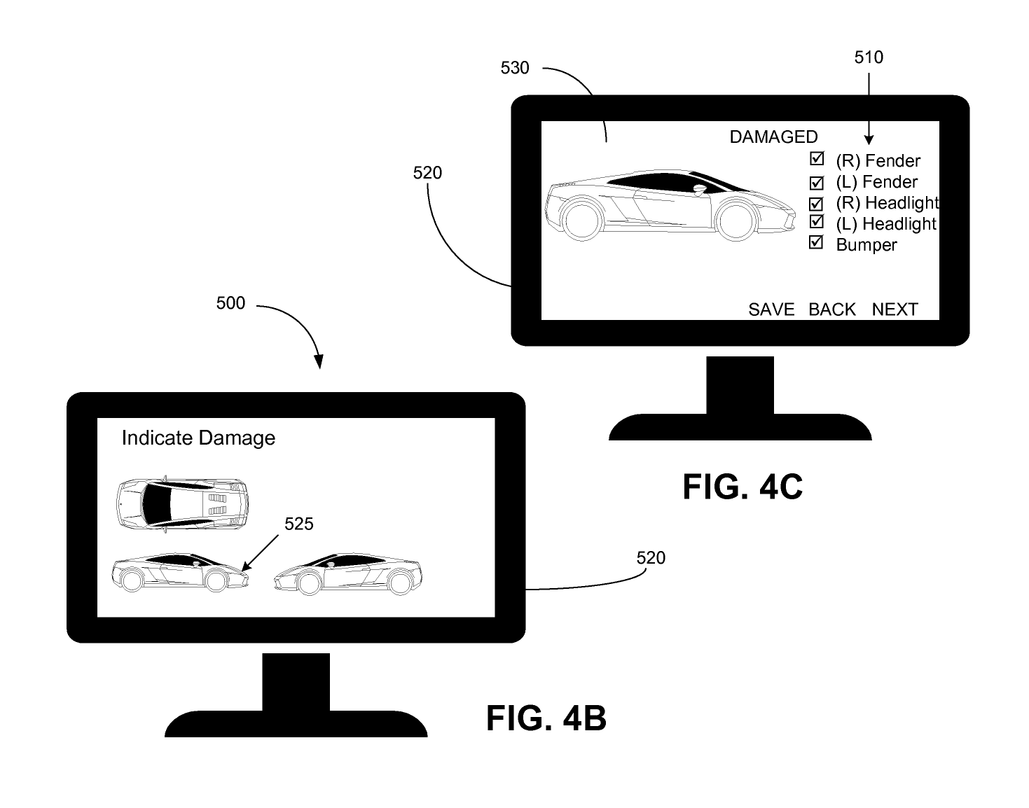

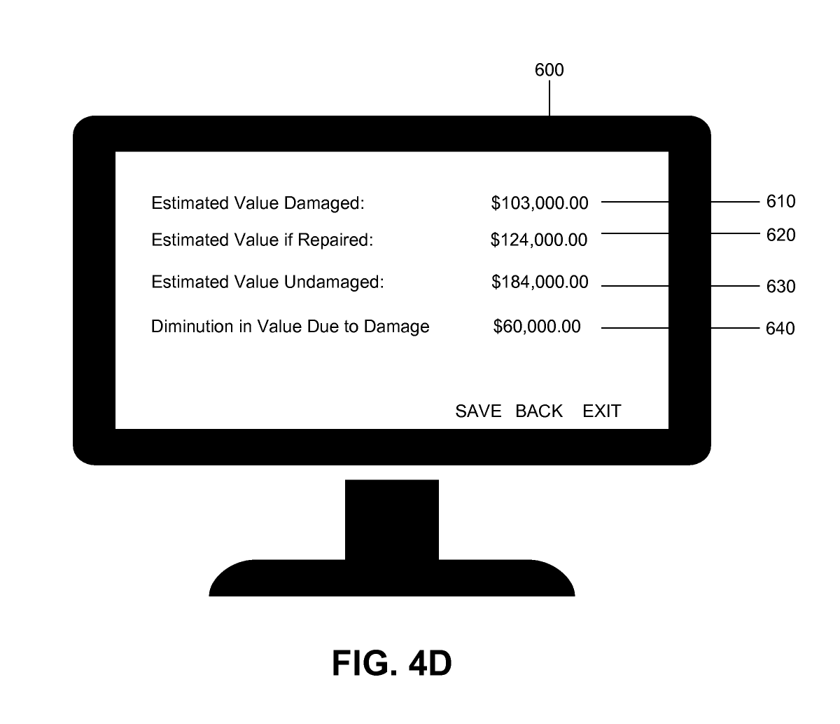

FIGS. 4A-4D depict exemplary screen displays which a user may experience when using the system to enter data for a particular damaged automobile. FIG. 4A depicts an automobile information entry screen 400 that illustrates a number of fields for the user to enter data about the automobile of interest that are utilized in the aforementioned estimation calculations. As may be understood from this figure, the automobile information entry screen 400 includes Customer Name 402 and Customer Address 404 entry fields that may be utilized on behalf of the owner of an automobile (e.g., a repair shop, insurance agency, auto broker, etc.) to store with repair estimates and prior automobile records. These fields, though labeled customer name and customer address in FIG. 4A, should be understood to be interchangeable with owner name and owner address depending on the application. As may be further understood from this figure, automobile information is entered in the following fields, such as registration type and location 406, the year of manufacture 408, make 410, model 412, mileage 416, type of title 424, number of airbags 428, and VIN number 434. As may further be understood from this figure, characteristics related to the damage sustained by the automobile are also entered, such as an estimate of the damage 414, whether the severity of the damage is known 418, whether the automobile is drivable 420, the location of the damage 422, whether the airbags deployed 426, whether the car sustained water damage 430, whether the glass broke 432, and whether casualties were sustained 436. In various embodiments, the information to be entered in FIG. 4A may be entered manually by the user, or populated by the system at least in part based on the VIN number or data available in third-party databases.

FIG. 4B depicts an exemplary screen display 500 of a visual, 3-dimensional model of the automobile 520, as defined by the data entered in FIG. 4A. As may be understood from this figure, the screen display 500 allows the user, upon inspection of the automobile or an adjustor's report, to select the portion of the automobile 525 that is damaged from any available view. Referring to FIG. 4C and as may be further understood from this figure, upon selection of the area of the damage 525 on the automobile 520, the automobile is shown to the user from that view 530, to allow the user to select from a list of pre-populated and standard automotive areas 510, to indicate the precise features that have sustained damage and will need to be repaired.

FIG. 4D depicts another exemplary screen display 600, depicting the system's estimation of a variety of valuations. As may be understood from this figure, the estimated value of a substantially similar damaged automobile 610 will be displayed to the user. This is an estimate of the automobile's value if it were to be sold prior to repair by the owner. The system may also display the estimated value of a substantially similar repaired automobile 620, which is the anticipated value of an automobile if it were to be sold by the owner after repairs. Moreover, the system may also display the estimated value of a substantially similar undamaged automobile 630, which is the anticipated value of the automobile immediately prior to sustaining damage. Lastly, the system may display the estimated diminution in value of the automobile 640, which is the amount the automobile has depreciated from the undamaged to repaired state, after sustaining damage in the interim.

### CONCLUSION

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed:

1. A computer-implemented method of valuing automotive assets, the method comprising:
a. receiving, by a processor, information from a user that is associated with an automobile that has been damaged, wherein the information contains at least the make, model, trim, automobile age, mileage and an estimate of the damage sustained by the automobile;
b. at least partially in response to receiving the information from the user, selecting, by a processor, a statistical formula that is derived from actual sales data for damaged automobiles that are substantially similar to the automobile defined by the received data;
c. calculating an estimated value of the damaged automobile by applying the received information to the selected statistical formula;
d. at least partially based on the calculated estimated value, determining a diminished value associated with the damaged automobile if the damaged automobile were to be repaired; and
e. at least one of: (i) displaying at least one of the estimated value of the damaged automobile and the diminished value and (ii) exporting at least one of the estimated value of the damaged automobile and the diminished value to a third-party system.

2. The computer-implemented method of claim 1, wherein the received information comprises one or more pieces of information selected from a group consisting of:
a. automobile year;
b. mileage;
c. repair estimate information;
d. severity of damage;
e. damage location;
f. automobile drivability;
g. geographic location of the automobile;
h. location of the damage on the automobile;
i. the type of title associated with the automobile;
j. whether the airbags deployed;
k. the number of airbags deployed;
l. whether the automobile sustained water damage;
m. whether there was any glass breakage;
n. vehicle identification number; and
o. severity of casualties resulting from the damage.

3. The computer-implemented method of claim 2, further comprising:
a. presenting, by a processor, a graphical representation of an automobile;
b. receiving, by a processor, user inputs on the graphical representation of the automobile to indicate areas of damage sustained by the automobile; and
c. saving the received user inputs in memory that is operatively coupled to the processor, wherein the user inputs are converted to data that is used by the statistical formula for calculating the estimated value of the damaged automobile.

4. The computer-implemented method of claim 2, further comprising the step of reducing correlations in the received information by calculating, by a processor, the average miles per year for the damaged automobile.

5. The computer-implemented method of claim 1, wherein the step of determining the diminished value further comprises:
a. selecting, by a processor, a second statistical formula that is derived from actual sales data for repaired automobiles that are substantially similar to the automobile defined by the received data; and
b. calculating an estimated value of the repaired automobile by applying the received information to the second selected statistical formula.

6. The computer-implemented method of claim 5, wherein the step of determining the diminished value further comprising:
a. selecting, by a processor, a third statistical formula that is derived from actual sales data for undamaged automobiles that are substantially similar to the automobile defined by the received data; and
b. calculating an estimated value of the undamaged automobile by applying the received information to the third selected statistical formula.

7. The computer-implemented method of claim 6, wherein the diminished value is at least partially based on comparing the calculated estimated value of the repaired automobile to the calculated estimated value of the undamaged automobile.

8. The computer-implemented method of claim 1, wherein the first statistical formula is derived from actual sales data for damaged automobiles for the exact make, model, and trim of the automobile defined by the received data.

9. The computer-implemented method of claim 6, wherein
a. the second statistical formula is derived from actual sales data for repaired automobiles for the exact make, model, and trim of the automobile defined by the received data; and
b. the third statistical formula is derived from actual sales data for undamaged automobiles for the exact make, model, and trim of the automobile defined by the received data.

10. The computer-implemented method of claim 1, wherein when a statistical formula that is derived from actual sales data for damaged automobiles that are substantially similar to the automobile defined by the received data is not available:
a. the step of selecting a statistical formula further comprises:
i. identifying a surrogate automobile that is similar to the automobile defined by the received data;
ii. selecting a first surrogate statistical formula that is derived from actual sales data for damaged surrogate automobiles; and
iii. selecting a second surrogate statistical formula that is derived from actual sales data for undamaged surrogate automobiles;
b. the step of calculating an estimated value of the damaged automobile by applying the received information to the selected statistical formula further comprises:
i. applying the received information to the first surrogate statistical formula to calculate an estimated value for a damaged surrogate automobile; and
ii. applying the received information to the second surrogate statistical formula to calculate an estimated value for an undamaged surrogate automobile;
c. further comprising:
i. calculating, by a processor, a ratio of the estimated value for the damaged surrogate automobile to the estimated value for the undamaged surrogate automobile;
ii. selecting, by a processor, a second statistical formula that is derived from actual sales data for undamaged automobiles that are substantially similar to the automobile defined by the received data;
iii. applying the received information to the second statistical formula to calculate an estimated value for an undamaged automobile that is substantially similar to the automobile defined by the received data; and
iv. calculating, by a processor, an estimated value of the damaged automobile defined by the received data by applying the ratio to the estimated value for the undamaged automobile that is substantially similar to the automobile defined by the received data.

11. A computer system for valuing automotive assets, the system comprising:
a. at least one processor;
b. memory operatively coupled to the at least one processor; and
c. at least one display operatively coupled to the at least one processor;
wherein the at least one processor is configured to:
i. receive information from a user that is associated with an automobile that has been damaged, wherein the information contains at least the make, model, trim, age, mileage and an estimate of the damage sustained by the automobile;
ii. select a statistical formula that is derived from actual sales data for damaged automobiles that are substantially similar to the automobile defined by the received data;
iii. calculating an estimated value of the damaged automobile by applying the received information to the selected statistical formula; and
iv. at least one of: (i) display the estimated value of the damaged automobile and (ii) export the estimated value of the damaged automobile to a third-party system.

12. The computer system of claim 11, wherein the received information further comprises one or more pieces of information selected from a group consisting of:
a. automobile year;
b. mileage;
c. repair estimate information;
d. severity of damage;
e. damage location;
f. automobile drivability;
g. geographic location of the automobile;
h. location of the damage on the automobile;
i. the type of title associated with the automobile;
j. whether the airbags deployed;
k. the number of airbags deployed;
l. whether the automobile sustained water damage;
m. whether there was any glass breakage;
n. vehicle identification number; and
o. severity of casualties resulting from the damage.

13. The computer system of claim 11, wherein the at least one processor is further configured to:
a. select a second statistical formula that is derived from actual sales data for undamaged automobiles that are substantially similar to the automobile defined by the received data;
b. select a third statistical formula that is derived from actual sales data for repaired automobiles that are substantially similar to the automobile defined by the received data;
c. calculate an estimated value of an undamaged automobile by applying the received data to the second statistical formula; and
d. calculate an estimated value of a repaired automobile by applying the received information to the third selected statistical formula.

14. The computer system of claim 13, wherein the at least one processor is further configured to:
a. calculate a ratio of the estimated value of the damaged automobile to the estimated value of the undamaged automobile;
b. compare the calculated ratio to a predefined range;
c. if the calculated ratio is outside the predefined range, flag the estimated value of the damaged automobile for further analysis.

15. The computer system of claim 11, wherein the at least one processor is further configured to define a lower bound to the estimated value of the damaged automobile that is at least partially based on the scrap value of the damaged automobile defined by the received data.

16. The computer system of claim 12, wherein the processor is further configured to verify at least one of the make, model, trim, and automobile year based on the vehicle identification number.

17. A computer-implemented method of valuing a damaged automobile, the method comprising:
a. receiving, by a processor, information from a user that is associated with an automobile that has been damaged, wherein the information contains at least the make, model, trim, automobile age, mileage and an estimate of the damage sustained by the automobile;
b. in response to receiving the information from the user, selecting, by a processor,
i. a first statistical formula that is derived from actual sales data for damaged automobiles that are substantially similar to the automobile defined by the received data;
ii. a second statistical formula that is derived from actual sales data for repaired automobiles that are substantially similar to the automobile defined by the received data; and
iii. a third statistical formula that is derived from actual sales data for undamaged automobiles that are substantially similar to the automobile defined by the received data;
c. calculating, by a processor,
i. an estimated value of the damaged automobile by applying at least some of the received information to the selected first statistical formula;
ii. an estimated value of a repaired automobile by applying at least some of the received information to the selected second statistical formula; and
iii. an estimated value of an undamaged automobile by applying at least some of the received information to the selected third statistical formula;
d. at least partially based on the calculated estimated value for at least one of the damaged automobile, the repaired automobile, and the undamaged automobile, determining at least one of:
i. an offer price to purchase the damaged and unrepaired automobile;
ii. an offer price to purchase the repaired damaged automobile; and
iii. a diminished value associated with the damaged automobile if the damaged automobile were to be repaired;
e. at least one of: (i) displaying at least one of the offer price to purchase the damaged and unrepaired automobile, the offer price to purchase the repaired damaged automobile, and the diminished value and (ii) exporting to a third-party system at least one of the offer price to purchase the damaged and unrepaired automobile, the offer price to purchase the repaired damaged automobile, and the diminished value.

18. The computer-implemented method of claim 17, wherein when a first statistical formula that is derived from actual sales data for damaged automobiles that are substantially similar to the automobile defined by the received data is not available:
a. the step of selecting a first statistical formula further comprises:
i. identifying a surrogate automobile that is similar to the automobile defined by the received data;
ii. selecting a first surrogate statistical formula that is derived from actual sales data for damaged surrogate automobiles; and
iii. selecting a second surrogate statistical formula that is derived from actual sales data for undamaged surrogate automobiles;
b. the step of calculating an estimated value of the damaged automobile by applying the received information to the selected first statistical formula further comprises:
i. applying the received information to the first surrogate statistical formula to calculate an estimated value for a damaged surrogate automobile; and
ii. applying the received information to the second surrogate statistical formula to calculate an estimated value for an undamaged surrogate automobile;
c. further comprising:
i. calculating, by a processor, a ratio of the estimated value for the damaged surrogate automobile to the estimated value for the undamaged surrogate automobile; and
ii. calculating, by a processor, an estimated value of the damaged automobile defined by the received data by applying the ratio to the estimated value for the undamaged automobile that is substantially similar to the automobile defined by the received data.

19. The computer-implemented method of claim 17, wherein receiving information from a user further comprises receiving multiple data sets in a batch file.

20. The computer-implemented method of claim 19, wherein the step of at least displaying or exporting at least one of the offer price to purchase the damaged and unrepaired automobile, the offer price to purchase the repaired damaged automobile, and the diminished value further comprises exporting a output batch file containing calculated values for each of the multiple data sets in the received batch file.
